(19) United States
(12) Patent Application Publication
(10) Pub. No.: US 2011/0005358 A1
(43) Pub. Date: Jan. 13, 2011

(54) SCREWDRIVER HANDLE WITH STORAGE COMPARTMENT

(75) Inventor: Shiyu Sun, Shanghai (CN)

Correspondence Address: SUITER SWANTZ PC LLO, 14301 FNB PARKWAY, SUITE 220, OMAHA, NE, 68154, US

(73) Assignee: SHANGHAI EASY-USE TOOLS ENTERPRISE CO., LTD., Shanghai (CN)

(21) Appl. No.: 12/567,152

(22) Filed: Sep. 25, 2009

(30) Foreign Application Priority Data
Jul. 13, 2009 (CN) 200920078168.9

(51) Int. Cl. B25G 1/08; B25B 23/16

(52) U.S. Cl. 81/177.4; 81/490

(57) ABSTRACT

The present disclosure is directed to a screwdriver handle having a storage compartment. The screwdriver handle may comprise a connecting rod, a handle body and a rear cap connected in series; the connecting rod includes rod body, which is equipped with hollow plug hole inside, and the other end of the rod body is connected to the handle body. The handle body is provided with a storage compartment that can hold precision screwdriver and spare sleeve.

### CROSS-REFERENCE TO RELATED APPLICATIONS

The present application claims priority based on Chinese Application No. 200920078168.9 filed Jul. 13, 2009, the disclosure of which is hereby incorporated by reference in its entirety.

### TECHNICAL FIELD

The present disclosure generally relates to a screwdriver as hand tool, and more particularly to a handle for screwdriver that incorporates bits, sleeve and precision screwdriver.

### BACKGROUND

Traditional screwdrivers have handle and bits processed as a whole. When the user needs to use different specifications or models of screwdrivers, the user must carry a big tool kit containing different kinds of screwdrivers. Among existing technologies, there are some techniques which process handle and bits of the screwdriver independently and include different sizes of bits into the handle. For instance, the Chinese patent numbered CN201151102 publicizes a kind of screwdriver handle, whose body has several screwdriver bit slots for holding screwdriver bits. Screwdriver bits can be inserted and stuck from back end opening of screwdriver bit slot. A user may push back the front end opening of the screwdriver bit slot to retrieve the screwdriver bits.

### SUMMARY

Accordingly, the present disclosure is directed to a screwdriver handle which leverages its handle body structure to get more storage space, and meanwhile carry bits, sleeve and other small tools.

The screwdriver handle described in the present disclosure includes a connecting rod, a handle body and a rear cap connected in series; the connecting rod includes rod body, which is equipped with hollow plug hole inside, and the other end of the rod body is connected to the handle body. The handle body is provided with a storage compartment that can hold precision screwdriver and spare sleeve.

It is to be understood that both the foregoing general description and the following detailed description are exemplary only and are not necessarily restrictive of the disclosure as claimed. The accompanying drawings, which are incorporated in and constitute a part of the specification, illustrate an embodiment of the disclosure and together with the general description, serve to explain the principles of the disclosure.

### BRIEF DESCRIPTION OF THE DRAWINGS

The numerous advantages of the present disclosure may be better understood by those skilled in the art by reference to the accompanying figures in which:

FIG. 1 is a side view of a screwdriver handle having a storage compartment;

FIG. 2 is an exploded view of the screwdriver handle having a storage compartment;

FIG. 3a is an isometric view of the screwdriver handle having a storage compartment;

FIG. 3b is another isometric view of the screwdriver handle having a storage compartment;

FIG. 4 is an exploded view of a rear cap and a sleeve of the screwdriver handle having a storage compartment;

FIG. 5 is a side view of the screwdriver connected with a drive bit;

FIG. 6 is a side view of the screwdriver connected with a sleeve; and

FIG. 7 is a side view of the screwdriver connected with an wrench handle.

### DETAILED DESCRIPTION

Reference will now be made in detail to the subject matter disclosed, which is illustrated in the accompanying drawings.

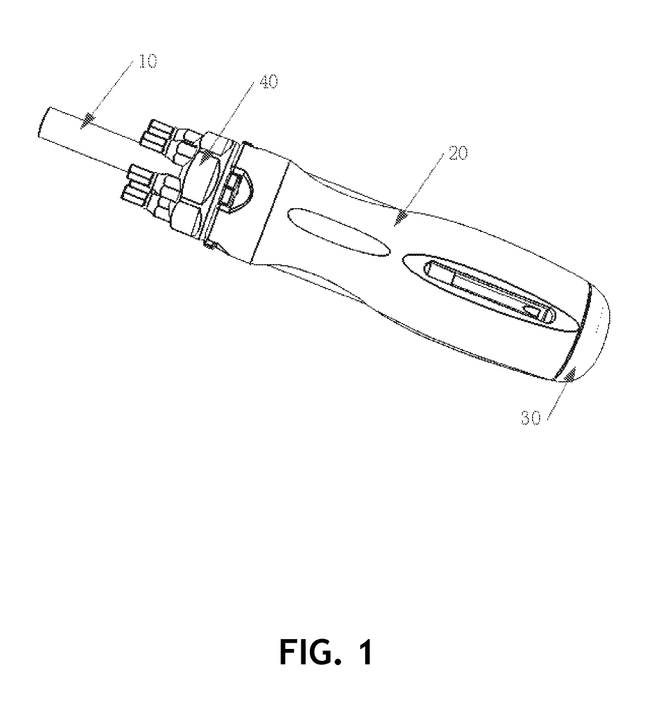

As shown in FIG. 1, the screwdriver handle with storage compartment/device in the present disclosure includes a connecting rod 10, a handle body 20 and a rear cap 30 connected in series. The screwdriver handle of the present disclosure is configured with a storage compartment for holding one or more drive bits, and the concave fetching hole set at front end of the socket makes it easier to take out and insert bits. The screwdriver handle of the present disclosure may also include a transparent window in handle body, which may enable the user to see clearly the items stored in the handle body. In addition, a wrench may be placed in the socket through the transparent window to serve as an elongate wrench handle for the screwdriver.

The screwdriver handle of the present disclosure may also comprise a hollow holding chamber formed at back end of the handle body for holding spare sleeves or other small tools. Furthermore, the screwdriver handle of the present disclosure may provide means for organizing the sleeves stored within. The screwdriver handle may also be configured for holding spare small tools.

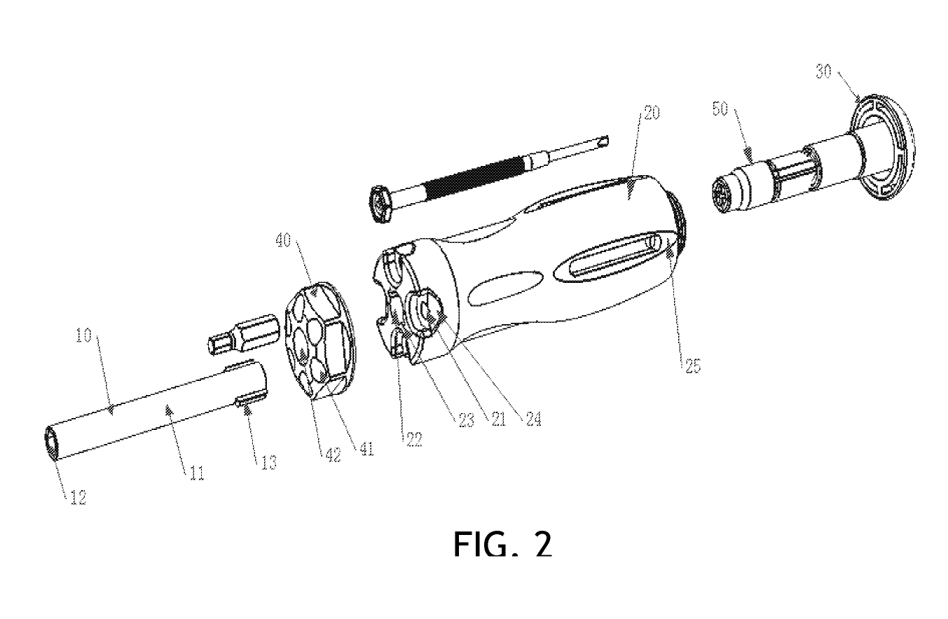

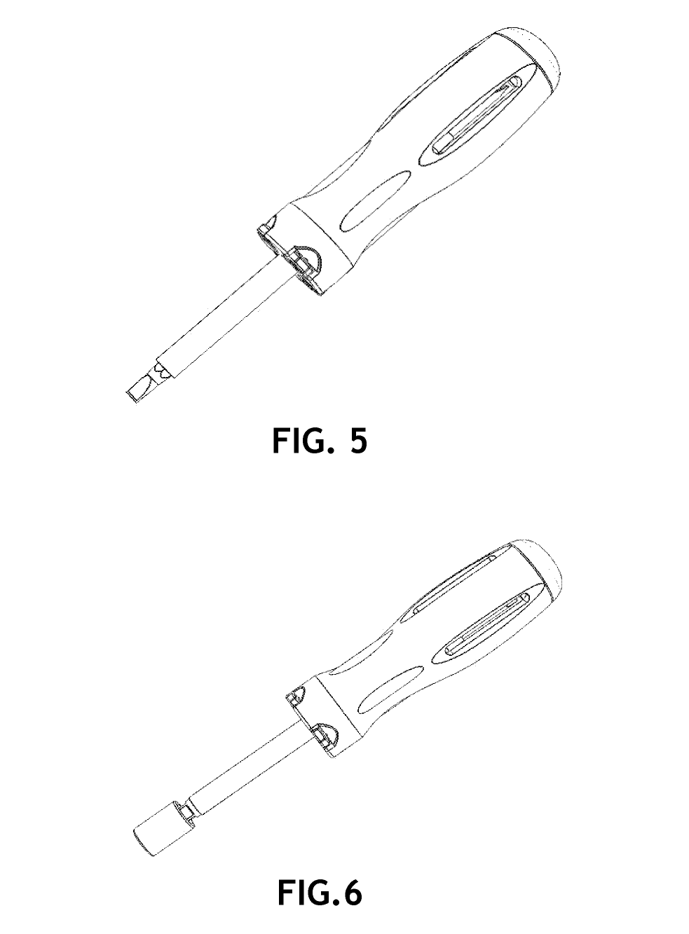

Please also refer to FIG. 2, FIG. 5 and FIG. 6. The connecting rod 10 includes a rod body 11. The rod body 11 is fitted with a hollow plug hole 12, which is inner hexagon shaped and used to install different sizes of bits. The end of the body 11 of the connecting rod 10 is provided with two connecting wedges 13 for connection to the handle body 20, and the connecting wedges 13 are distributed in axial symmetry on the side wall of rod body 11.

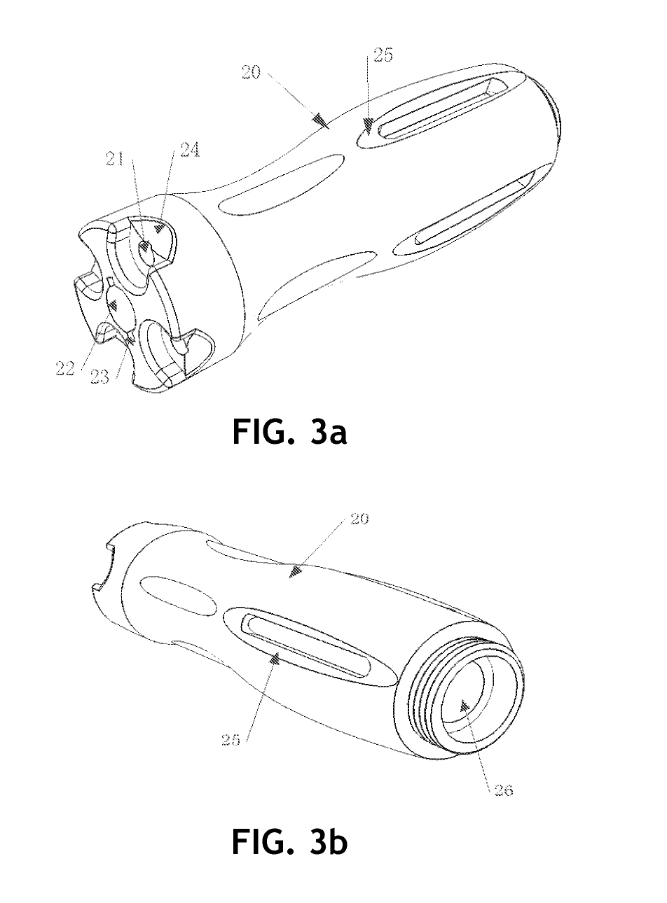

Please also refer to FIG. 3a and FIG. 3b. The front end of the handle body 20 is also provided with connecting hole 22 and connecting slot 23 at the perimeter of the connecting hole 22 which are together used for connection to the body 11 of The connecting rod 10 and connecting wedge 13.

The handle body 20 is provided with a storage device that can hold precision screwdriver, spare sleeve and other small tools.

The storage device includes sockets 21 which are set at the outer perimeter of the handle body 20 and can hold precision screwdriver, and insertion opening of the socket 21 is located at front end of the handle body 20. The insertion opening of the socket 21 is provided with concave fetching hole 24, which makes it easier to take out and insert bits.

Transparent window 25 is formed at the end of the socket 21. This transparent window 25 enables the user to see clearly the specification of precision screwdriver stored in the socket, thus making it easier for the user to choose the right bits according to realities.

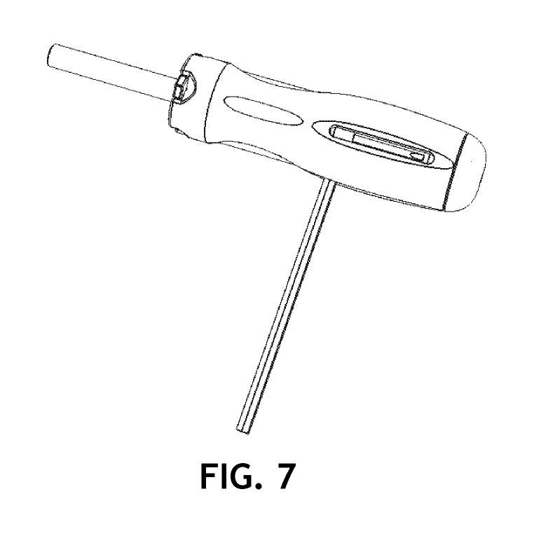

Please also refer to FIG. 7. The short arm of small-sized inner hexagonal wrench can be placed in the socket 21 through the transparent window 25, and thus serve as the handle of inner hexagonal wrench, so as to solve the issue that it is inconvenient to apply force on the short arm of inner hexagonal wrench.

The storage device also includes a hollow holding chamber 26 formed at back end of the handle body 20. The holding chamber 26 can house spare sleeves or other small tools.

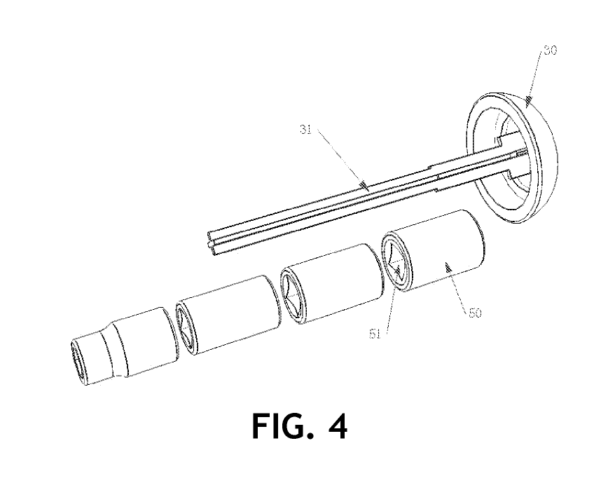

Please also refer to FIG. 4. The center of the rear cap 30 is also provided with core axle 31, which is connected in series to sleeve 50 through the plug hole 51 provided at the center of sleeve 50. As a result, the rear cap 30 and sleeve 50 form a sleeve cover. This arrangement helps prevent sleeves from being scattered and/or lost, and enables the user to take out sleeves more easily. The sleeve cover is connected to the holding chamber 26 of the handle body 20.

A connecting gasket 40 that can hold small tools are provided between the connecting rod 10 and handle body 20. Sockets 41 that can hold small tools are fitted on the perimeter of the connecting gasket 40, and the center of the gasket is provided with connecting hole 42 linked to the body 11 of the connecting rod 10.

The above is a detailed illustration of the preferred embodiment of the present disclosure. However, the present disclosure is not restricted to the preferred embodiment, and technical personnel familiar with this field can make various equivalent modifications or replacements without violating the spirit of invention and creation. Such equivalent modifications or replacements shall be included in the scope of restrictions on the present claim of rights pending approval.

What is claimed is:

1. A screwdriver handle, comprising:
a connecting rod (10), a handle body (20) and a rear cap (30) connected in series; the connecting rod (10) includes a rod body (11), the rod body (11) is provided with a hollow plug hole (12) inside, and an end of the rod body is connected to the handle body (20); wherein the handle body (20) is equipped with a storage compartment configured for holding precision screwdriver and spare sleeve.

2. The screwdriver handle of claim 1, wherein the storage compartment includes sockets (21) which are set at the outer perimeter of the handle body (20) and can hold precision screwdriver, and an insertion opening of the socket (21) is located at a front end of the handle body (20).

3. The screwdriver handle of claim 2, wherein the insertion opening of the socket (21) is provided with concave fetching hole (24).

4. The screwdriver handle of claim 2 or 3, wherein the end of the socket (21) has a transparent window (25).

5. The screwdriver handle of claim 4, wherein the storage compartment also includes a hollow holding chamber (26) formed at a back end of the handle body (20).

6. The screwdriver handle of claim 5, wherein a connecting wedge (13) provided at the end of the rod body (11) of the connecting rod (10) is connected to the handle body (20).

7. The screwdriver handle of claim 6, wherein the front end of the handle body (20) is also provided with a connecting hole (22) and a connecting slot (23) at the perimeter of the connecting hole (22) which are together used for connection to the body (11) of said connecting rod (10) and connecting wedge (13).

8. The screwdriver handle of claim 7, wherein a connecting gasket (40) that can hold small tools is provided between the connecting rod (10) and the handle body (20).

9. The screwdriver handle of claim 8, wherein the sockets (41) that can hold small tools is fitted on the perimeter of the connecting gasket (40), and the center of the gasket is provided with a connecting hole (42) connected to the body (11) of the connecting rod (10).

10. The screwdriver handle of claim 9, wherein the center of the rear cap (30) is also provided with a core axle (31), which is sheathed with a sleeve (50) to combine the rear cap (30) and the sleeve (50) into sleeve cover, which is connected to the holding chamber (26) of the handle body (20).
